(19) United States
(12) Patent Application Publication
(10) Pub. No.: US 2018/0137586 A1
(43) Pub. Date: May 17, 2018

(54) COACHING SUPPORT SYSTEM AND METHOD

(71) Applicant: COACH A CO., Ltd., Tokyo (JP)

(72) Inventor: Mamoru ITO, Tokyo (JP)

(21) Appl. No.: 14/780,985

(22) PCT Filed: Jun. 18, 2015
(86) PCT No.: PCT/JP2015/067655

§ 371 Date: Sep. 28, 2015

(30) Foreign Application Priority Data
Mar. 23, 2015 (JP) 2015-059312
Jun. 2, 2015 (JP) 2015-112511

(51) Int. Cl. G06Q 50/20; G06Q 10/10; G09B 5/06

(52) U.S. Cl. CPC G06Q 50/205; G09B 5/06; G06Q 10/1093

(57) ABSTRACT

In coaching support system, a first terminal which is a terminal of a client and a second terminal which is a terminal of a leader are connected to communicate with each other through a management server. The first terminal receives an input of time information indicating execution schedule date and time when the client executes a first coaching with respect to a stakeholder of the client, and transmits the time information to the management server. The first terminal further receives an input of coaching information including coaching history information indicating a history of the first coaching, and further transmits the coaching information to the management server. The management server records the coaching information from the first terminal in association with the time information, and transmits coaching information for a second coaching to be executed with respect to the client by the leader to the second terminal.

### CROSS-REFERENCE TO RELATED APPLICATION

This application is based on and claims priority from Japanese Patent Application No. 2015-059312 filed on Mar. 23, 2015 and Japanese Patent Application No. 2015-112511 filed on Jun. 2, 2015, and the contents of the above applications are incorporated herein by reference.

### TECHNICAL FIELD

The present invention relates to a coaching support system and a coaching support method.

### BACKGROUND ART

In the related art, coaching has been widely used in a business field. For example, in an organization such as a company, a boss may perform coaching with respect to subordinates.

In this regard, Patent Document 1 discloses a coaching providing method. Here, control means 11 requests an input of a target to be achieved or a problem to be overcome of a client terminal on the Internet INT, stores the input target to be achieved or problem to be overcome and client identification information in storage means 15 to be associated with each other one by one, and displays, when coaching information with respect to the target to be achieved or problem to be overcome is stored, the result in the client terminal. Further, the control means 11 displays the target to be achieved or problem to be overcome in a coach terminal, requests an input of coaching with respect to the target to be achieved or problem to be overcome, and stores the input coaching information and coach identification information in storage means 16 to be associated with each other one by one.

### CITATION LIST

### Patent Document

Patent Document 1: JP2004-272611 A

### DISCLOSURE OF THE INVENTION

### Problem to be Solved by the Invention

In the coaching providing method disclosed in Patent Document 1, coaching is executed only with respect to a client (a person who is coached) from a professional leader (coach) (a person who executes coaching). That is, the coaching is based on guidance on a one-to-one basis with respect to a client from a coach. Accordingly, since a certain amount of time is necessary for the coaching and there is a limit in the number of coaches, for example, in a large-sized organization, not all members of the organization can be directly coached by the leader.

In order to solve the above problem, an object of the present disclosure is to provide a coaching support system, and the like capable of promoting a spontaneous action change with respect to stakeholders of a client (for example, subordinates of a client or colleagues in other departments), in addition to the client who is directly coached by a coach, and supporting realization of a change of an entire organization including the client and the stakeholders.

According to an aspect of the present disclosure, there is provided a coaching support system comprising a first terminal which is a terminal of a client and a second terminal which is a terminal of a leader, the first and second terminals being connected to communicate with each other through a management server. The first terminal comprises an input reception section that receives an input of time information indicating execution schedule date and time when the client executes a first coaching with respect to a stakeholder of the client, and a first transmission section that transmits the time information to the management server; the input reception section further receives an input of coaching information including coaching history information indicating a history of the first coaching; the first transmission section further transmits the coaching information to the management server when the input of the coaching information is received in the input reception section; and the management server comprises a recording section that records the coaching information from the first terminal in association with the time information, and a second transmission section that transmits at least the coaching information to at least the second terminal so that the coaching information associated with the time information can be used in a second coaching to be executed with respect to the client by the leader.

According to another aspect of the present disclosure, there is provided a coaching support method in which a first terminal which is a terminal of a client and a second terminal which is a terminal of a leader are connected to communicate with each other through a management server. The coaching support method causes the first terminal to receive an input of time information indicating execution schedule date and time when the client executes a first coaching with respect to a stakeholder of the client, to transmit the time information to the management server, further to receive an input of coaching information including coaching history information indicating a history of the first coaching, and further to transmit the coaching information to the management server when the input of the coaching information is received. The coaching support method further causes the management server to record the coaching information from the first terminal in association with the time information, and to transmit at least the coaching information to at least the second terminal so that the coaching information associated with the time information can be used in a second coaching to be executed with respect to the client by the leader.

According to still another aspect of the present disclosure, there is provided a computer-readable recording medium on which processes for causing a computer to realize the steps of: receiving an input of time information indicating execution schedule date and time when the client executes a first coaching with respect to a stakeholder of the client, and further receiving an input of coaching information including coaching history information indicating a history of the first coaching; transmitting the time information to the management server, and further transmitting the coaching information to the management server when the input of the coaching information is received; recording the coaching information in association with the time information; and transmitting at least the coaching information so that the coaching information associated with the time information can be used in a second coaching to be executed with respect to the client by a leader, are recorded.

In the present disclosure, “section”, “device”, and “system” do not only mean physical means, but also include a case where functions of “section”, “device”, and “system” are realized by software. Further, a single function of “section”, “device”, or “system” may be realized by two or more physical means or devices, or two or more functions of “section”, “device”, or “system” may be realized by a single physical means or device.

### Effect of the Invention

According to the present disclosure, it is possible to record coaching information including coaching history information indicating a history of a first coaching executed with respect to a stakeholder of a client (for example, a subordinate) by the client (for example, a boss) in association with date and time when the coaching is executed, and to share the coaching information between the client, a coach, and the stakeholder of the client, and thus, it is possible to use the coaching information as coaching feedback information when the coach executes a second coaching with respect to the client. As a result, from the standpoint of the coach, it is possible to appropriately support the client so that the client who is directly coached by the coach executes an appropriate coaching with respect to stakeholders of the client, and thus, it is possible to promote a spontaneous action change through coaching from the client with respect to stakeholders (for example, subordinates of the client or colleagues in other departments) in addition to the client who is directly coached by the coach, and to realize a change of the entire organization including the client and the stakeholders.

### BRIEF DESCRIPTION OF THE DRAWINGS

FIG. 1 is a schematic diagram illustrating a configuration of a coaching support system according to an embodiment of the present disclosure.

FIG. 2 is a diagram illustrating an electric configuration of a terminal device according to the embodiment of the present disclosure.

FIG. 3 is a schematic diagram illustrating an electric configuration of a management server according to the embodiment of the present disclosure.

FIG. 4 is a diagram illustrating an example of a personal information database of a management server according to the embodiment of the present disclosure.

FIG. 5 is a diagram illustrating an example of a coaching history information database of a management server according to the embodiment of the present disclosure.

FIG. 6 is a diagram illustrating an example of a learning information database of a management server according to the embodiment of the present disclosure.

FIG. 7 is a diagram illustrating an example of a learning history information database of a management server according to the embodiment of the present disclosure.

FIG. 8 is a diagram illustrating an example of a question information database of a management server according to the embodiment of the present disclosure.

FIG. 9 is a diagram illustrating an image displayed in a display section of a terminal device according to the embodiment of the present disclosure.

FIG. 10 is a diagram illustrating an image displayed in the display section of the terminal device according to the embodiment of the present disclosure.

FIG. 11 is a diagram illustrating an image displayed in the display section of the terminal device according to the embodiment of the present disclosure.

FIG. 12 is a diagram illustrating an image displayed in the display section of the terminal device according to the embodiment of the present disclosure.

FIG. 13 is a diagram illustrating an image displayed in the display section of the terminal device according to the embodiment of the present disclosure.

FIG. 14 is a diagram illustrating an image displayed in the display section of the terminal device according to the embodiment of the present disclosure.

FIG. 15 is a diagram illustrating an image displayed in the display section of the terminal device according to the embodiment of the present disclosure.

FIG. 16 is a diagram illustrating an example of a flowchart of a coaching support system according to an embodiment of the present disclosure.

FIG. 17 is a diagram illustrating an example of the flowchart of the coaching support system according to the embodiment of the present disclosure.

FIG. 18 is a diagram illustrating an example of the flowchart of the coaching support system according to the embodiment of the present disclosure.

### MODE FOR CARRYING OUT THE INVENTION

Hereinafter, embodiments of the present disclosure will be described with reference to the accompanying drawings. Here, the embodiments described hereinafter are only examples, and should not be construed to exclude application of various modifications or techniques which are not obviously described below. That is, the present disclosure may include various modifications (combinations of the respective embodiments, for example) in a range without departing from the spirit of the present disclosure. Further, in illustration of the accompanying drawings, the same or similar reference numerals are given to the same or similar parts. The drawings are schematic, and do not necessarily match actual sizes, ratios thereof, or the like. Between the drawings, parts having different relations or ratios of sizes may be included.

In this disclosure, “coaching” refers to a technique for appropriately performing communication such as asking a target person a question and receiving feedback to promote the target person to be aware of his/her problem and to cause the target person to realize a spontaneous action change. The coaching is not one-sidedly executed by a coach, but the target person has his/her own thinking using a question or the like from the coach as a trigger to solve the problem.

In this embodiment, with respect to coaching executed between a leader (coach), a client who is coached by the coach, and a stakeholder (SH) of the client who is coached by the client, a coaching executed between the client and the stakeholder is referred to as a “first coaching”, and a coaching executed between the coach and the client is referred to as a “second coaching”.

Further, the coaching is generally executed in a one-to-one relationship, but it is not essential to execute the coaching in the one-to-one relationship. For example, one coach may execute coaching with respect to plural clients at the same time, or plural clients may execute coaching with respect to one stakeholder at the same time. It is more effective to execute coaching with high frequency in the one-to-one relationship.

In this embodiment, the client can improve his/her own ability through learning in a predetermined (on-line) class (which will be described later), the second coaching with the coach, the first coaching with the stakeholder, or the like, to thereby realize a spontaneous action change.

[Configuration of coaching support system]

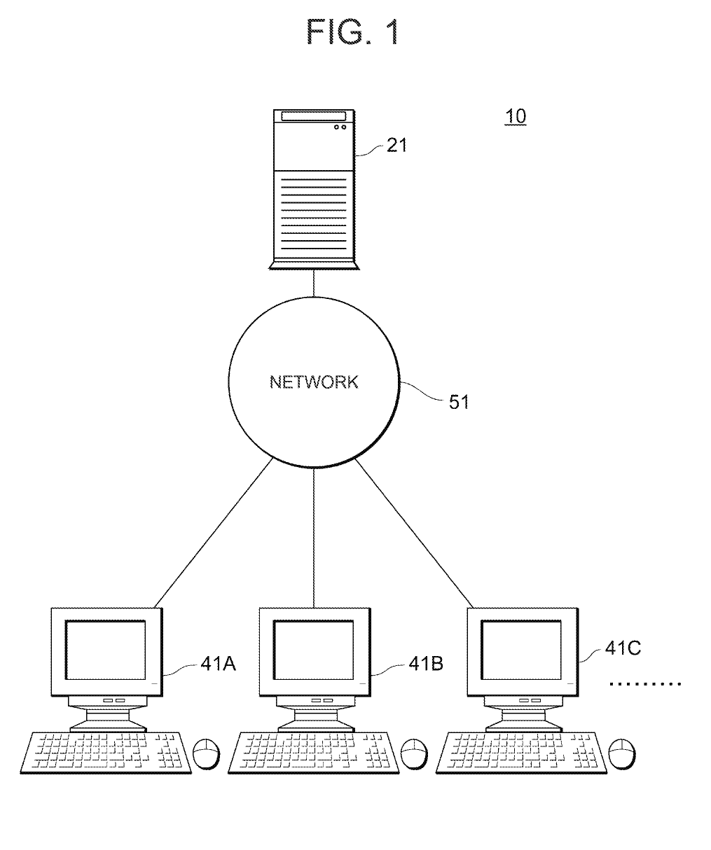

FIG. 1 is a schematic diagram illustrating a configuration of a coaching support system according to an embodiment of the present disclosure. As shown in FIG. 1, a coaching support system 10 includes a management server 21, and terminal devices 41A, 41B, and 41C, for example. The management server 21 that controls a variety of information relating to coaching and/or learning provided in each of the terminal devices 41A, 41B, and 41C is connectable to a network 51 that includes the Internet, an exclusive line, a provider, a sound communication station, a mobile phone base station, a satellite communication station, and the like, and each of the terminal devices 41A, 41B, and 41C is able to communicate with the management server 21 through the network 51.

In FIG. 1, only the management server 21 is shown as a server connected to the network 51, but the present disclosure is not limited thereto, and a configuration in which functions of the management server 21 (which will be described later) are divided into plural servers may be used. Further, a configuration in which plural management servers 21 are provided and an external server that collectively manages the management servers 21 is provided may be used, which is convenient.

The plural terminal devices 41A, 41B, 41C, and the like are connectable to the network 51, and the management server 21 may be accessed from the plural terminal devices 41A, 41B, 41C, and the like.

Each of the terminal devices 41A, 41B, 41C, and the like uses a personal computer 41A, but the present disclosure is not limited thereto, and any terminal device through which a user can access the network 51 may be used. The terminal device that can access the network 51 includes a note type personal computer, a mobile personal computer, or a communication terminal device such as a mobile phone or a personal digital assistant (PDA), for example, in addition to the personal computer 41A.

Between each of the terminal devices 41A, 41B, 41C, and the like, and the network 51 (a host computer of a provider) such as the Internet, for example, exchange of a packet created by a TCP/IP protocol group is performed using a dial-up point-to-point protocol (PPP) connection. Further, in the network 51 (between the host computer of the provider and the management server 21), for example, communication based on the TCP/IP protocol is performed. In this embodiment, a configuration in which the communication with the network 51 can be performed through the management server 21 using a wired terminal device which is a personal computer is used, but the present disclosure is not limited to thereto, and a wired manner or a wireless manner does not matter as long as the communication can be performed.

Further, in this embodiment, a configuration in which the terminal devices 41A, 41B, 41C, and the like are connected to the management server 21 to be indirectly connected to the network 51 is used, but the present disclosure is not limited thereto, and the terminal devices 41A, 41B, 41C, and the like may be directly connected to the network 51. Further, in this embodiment, the management server 21 is connected to directly communicate with the terminal devices 41A, 41B, 41C, and the like through the network 51, but the present disclosure is not limited thereto, and any configuration in which the management server 21 is connected to communicate with the plural terminal devices such as the terminal devices 41A, 41B, 41C, and the like may be used. For example, a configuration in which the management server 21 is connected to indirectly communicate with the terminal devices 41A, 41B, 41C, and the like may be used, or a configuration in which the management server 21 is connected to communicate with the terminal device 41A through the network 51, the management server 21 is not directly connected to the terminal device B, and the terminal device 41A and the terminal device 41B are connected to communicate with each other may be used.

[Configuration of terminal device]

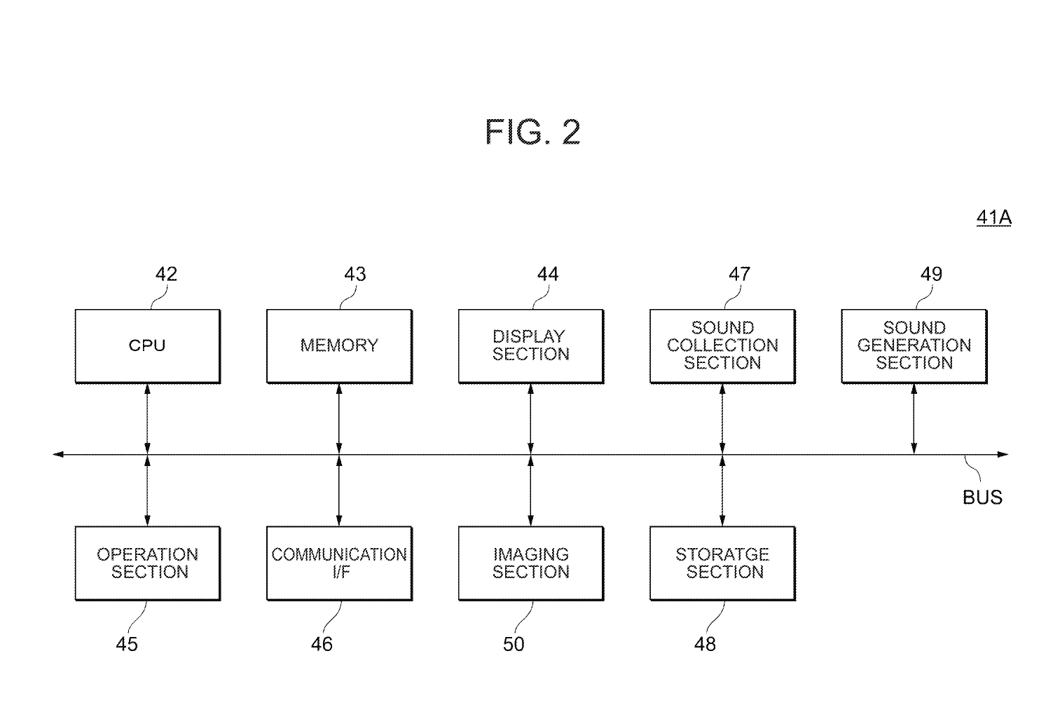

FIG. 2 is a diagram illustrating an electric configuration of a terminal device according to an embodiment of the present disclosure. Here, the terminal device 41A is described, but the other terminal devices 41B, 41C, and the like have the same configuration.

As shown in FIG. 2, for example, the terminal device 41A includes a CPU 42, a memory 43, a communication interface 46 (hereinafter, referred to as a communication I/F) that performs transmission and reception of information, a display section 44 that is configured by a liquid crystal display panel, a CRT, or the like, an operation section 45 that includes a keyboard, a mouse, a jog dial, or the like operated by a user (coach, client, stakeholder, or the like) of the coaching support system of this embodiment, a storage section 48 that stores a variety of data, a sound collection section 47 that collects sound, such as a microphone, a sound generation section 49 that generates sound, such as a speaker, and an imaging section 50 that captures an image, such as a camera. The respective components of the terminal device 41A are connected to each other through a data bus BUS.

For example, the respective components of the terminal device 41A are independently or cooperatively operated as an “input reception section” that receives an input of at least a variety of information, a “transmission section” that transmits a variety of information, a “reception section” that receives a variety of information, a “display control section” that displays a variety of image information, or the like.

The CPU 42 executes various operations according to operation programs stored in the storage section 48, temporarily stores the operation programs, and variable or the like generated by the operation programs, and the like in the memory 43, and controls operations of the respective components of the terminal device 41A according to the operations. A variety of processing content of the CPU 42 is displayed in the display section 44 as necessary.

The input reception section of the terminal device 41A receives an information input of a user of the coaching support system of this embodiment. The input reception section receives an input of time information indicating execution schedule date and time when the client executes the first coaching with respect to the stakeholder, for example. Further, the input reception section further receives an input of coaching information including coaching history information indicating a history of the first coaching, for example.

The transmission section (a first transmission section) of the terminal device 41A transmits a variety of information to another device. The transmission section transmits time information indicating execution schedule date and time when the client executes the first coaching with respect to the stakeholder to another device (for example, the management server 21), for example. Further, for example, when the input of the coaching information is received in the input reception section, the transmission section further transmits the coaching information to another device (for example, the management server 21).

The reception section of the terminal device 41A receives a variety of information from an external device. The reception section receives the time information indicating execution schedule date and time when the client executes the first coaching with respect to the stakeholder, and the coaching information indicating the coaching history information indicating the history of the first coaching associated with the time information, stored in the management server 21 (which will be described later), from the management server 21, for example.

The display control section of the terminal device 41A performs a control for displaying an image corresponding to a variety of image information in the display section 44. For example, the display control section performs a control for displaying, based on the time information and the coaching information associated with the time information, the coaching information for each date and time when the first coaching is executed. Further, the display control section list-displays the coaching information for each date and time when the first coaching is executed, displayed to be associated with each date and time when the first coaching is executed, for example.

In the first coaching, the client and the stakeholder may communicate with each other in a face-to-face manner without passing through the terminal device, or may communicate with each other through the terminal device. Further, in the second coaching, the leader and the client may communicate with each other through the terminal device, or may communicate with each other without passing through the terminal device. In the first or second coaching, when the terminal device is used, for example, information relating to facial expressions, operations of the whole body, and sound of the coach, client, and stakeholder may be collected using the imaging section 50 and the sound collection section 47 provided in the terminal device, and may be used as coaching (history) information. On the other hand, in the first or second coaching, when the terminal device is not used, information relating to facial expressions, operations of the whole body, and sound of the coach, client, and stakeholder may be collected using any imaging device (camera or the like) and any sound collection device (microphone or the like), and may be used as coaching (history) information.

[Configuration of management server]

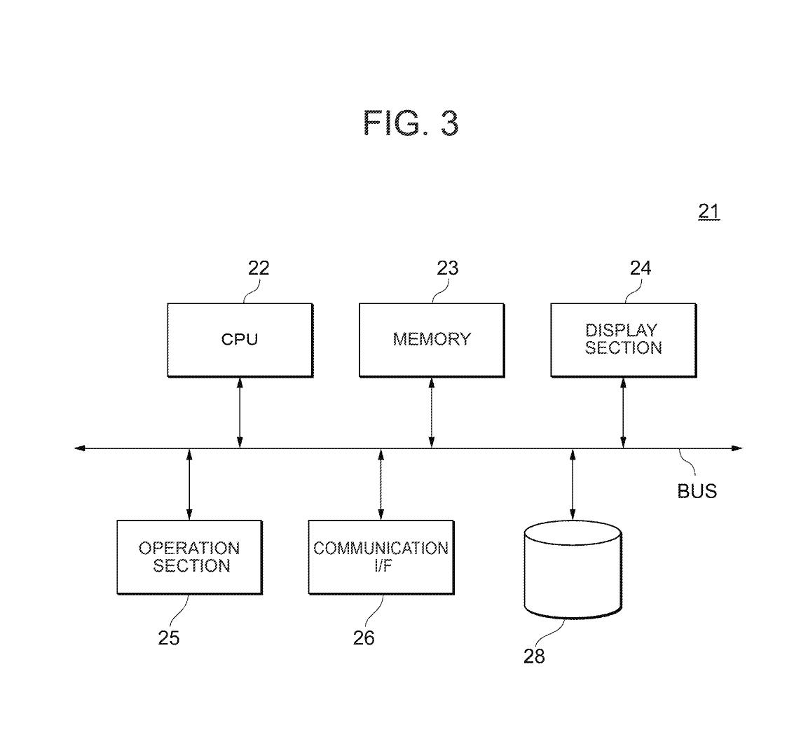

FIG. 3 is a schematic diagram illustrating an electric configuration of a management server according to an embodiment of the present disclosure. As shown in FIG. 3, in the management server 21, a CPU 22 which is a control unit, a memory 23, a display section 24 that displays an image, an operation section 25 that is operated by a user of the coaching support system of this embodiment, a communication I/F 26, and a recording section 28 that is configured by redundant arrays of inexpensive disks (RAID) are connected to a data BUS.

For example, in the above configuration in this embodiment, the components are independently or cooperatively operated as a “schedule creation section” that creates a schedule of learning and/or coaching, a “reception section” that receives a variety of information, a “recording section” that records a variety of information, and a “transmission section” that transmits a variety of information. In the recording section 28 of the management server 21, programs for managing the coaching support system 10 shown in FIG. 1, specifically, programs for providing, acquiring, and managing information relating to a variety of learning, such as a program for performing communication with the terminal devices 41A, 41B, 41C, and the like, are stored.

The CPU 22 executes various operations according to the programs stored in the recording section 28, and temporarily stores the programs, and variables, data or the like generated by the operation programs in the memory 23, and controls respective circuit sections according to the operations. Although details will be described later, a variety of processing is executed according to control programs, or a variety of content or programs thereof stored in the recording section 28. That is, the CPU 22 performs transmission and reception of a variety of information relating to coaching and/or learning with each of the terminal devices 41A, 41B, 41C, and the like through a line connected to the communication I/F 26 and the network 51.

The schedule creation section of the management server 21 creates a schedule of learning and/or coaching of a user of the system of this embodiment. The schedule creation section creates a participation plan based on date and time when the client participates in a predetermined lecture (including at least an on-line class, a coaching class, and a phone conference class), for example. The schedule creation section creates the participation plan based on lecture information indicating a lecture desired by the client, and participation time information indicating a desired participation time based on date and time, received from the client.

The recording section of the management server 21 records a variety of information. The recording section records coaching information from a terminal (a first terminal) of a client in association with time information, for example.

The transmission section of the management server 21 transmits a variety of information to another device. The transmission section at least transmits coaching information to a terminal (a second terminal) of a leader so that time information and coaching information associated with the time information can be used in the second coaching executed with respect to the client by the coach (leader).

[Configuration of recording section in management server]

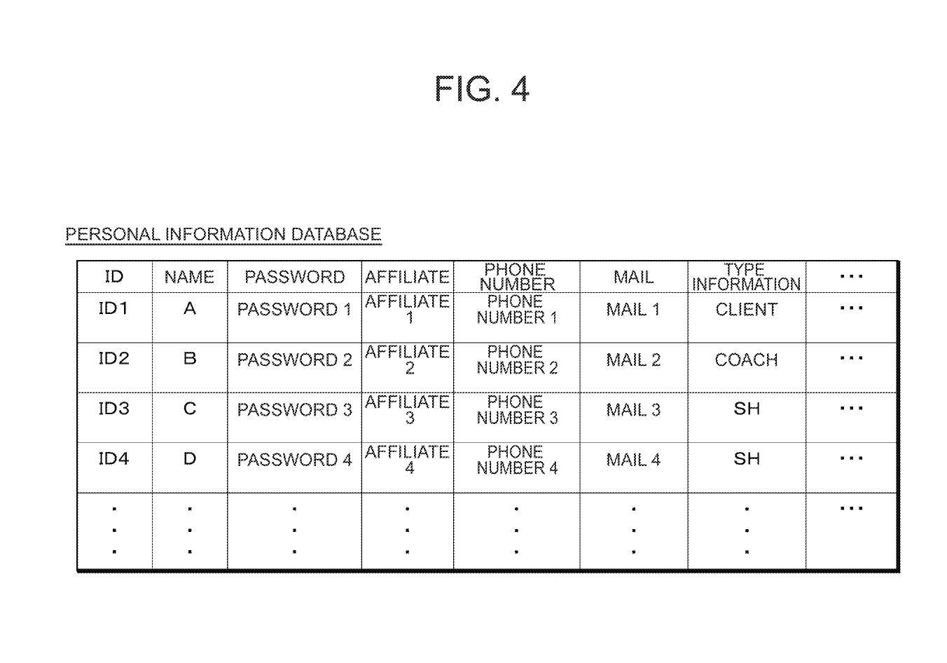

A database as shown in FIGS. 4 to 8 is recorded in the recording section 28 in the management server 21. The “database” in this embodiment has functions of providing a procedure of input, updating, retrieval and the like of data and realizing collective management of information, and includes a relational database that performs a process while associating a certain record in a certain table with a certain record in another table.

FIG. 4 is a diagram illustrating an example of a personal information database of a management server according to an embodiment of the present disclosure. As shown in FIG. 4, the personal information database stores information on users of the coaching support system 10, for example, a leader (coach), a client coached by the coach, and a stakeholder (SH) coached from the client to be associated with each other. As items that form the information, for example, a variety of information such as “ID”, “name”, “password”, “affiliate” (address or the like), “phone number”, “mail” (electronic mail) address, and “type information” indicating the “type” of a coach, a client, or a stakeholder is associated with each other.

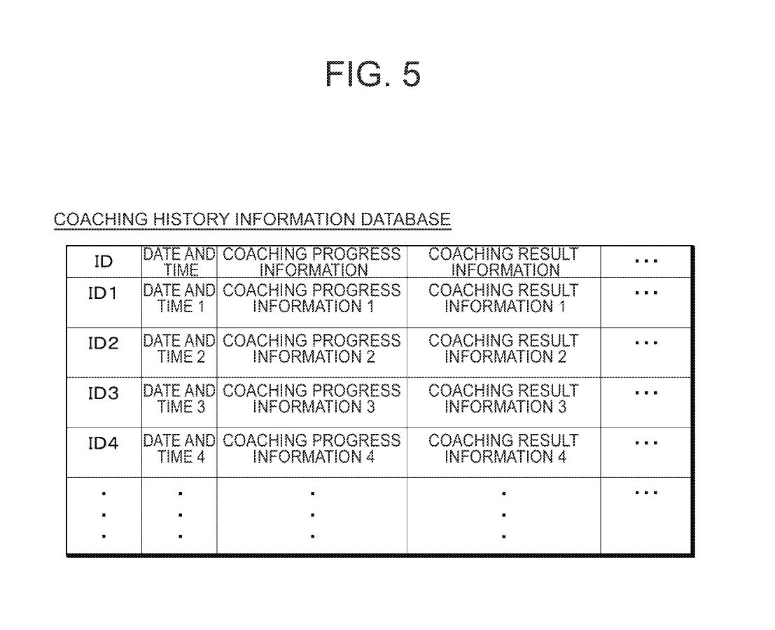

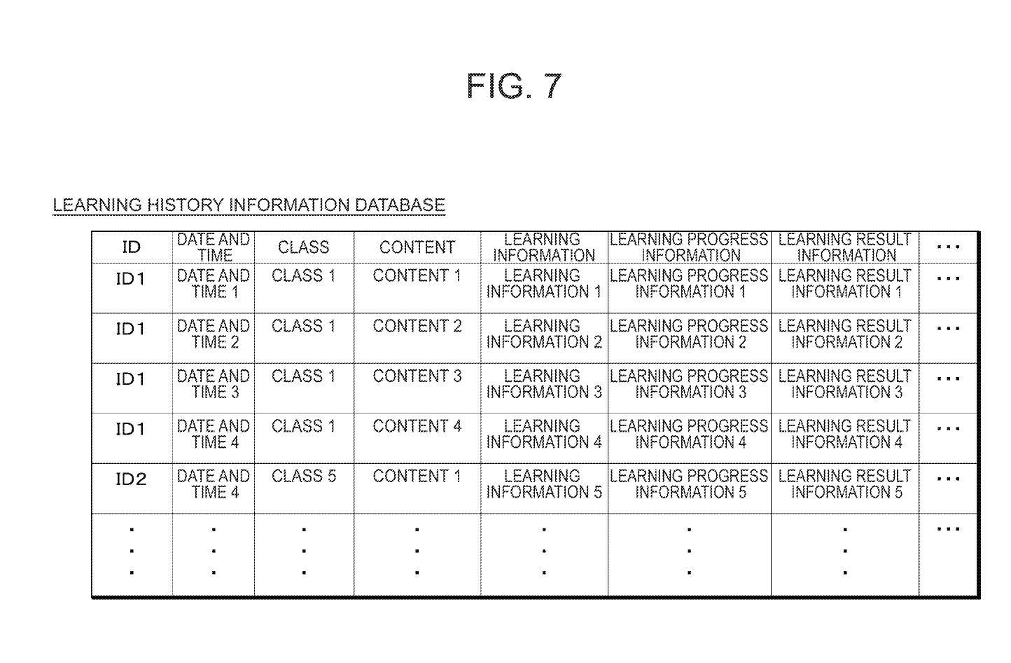

The management server 21 receives “ID” and “password” of a user of the coaching support system 10 from the terminal devices 41A, 41B, 41C, and the like, for example, to determine communication destination information such as a mail address of the user with reference to the personal information database. Further, the items such as “ID” in the personal information database is, for example, associated with a coaching history information database (see FIG. 5), a learning history information database (see FIG. 7), or the like which will be described later.

FIG. 5 is a diagram illustrating an example of a coaching history information database of a management server according to an embodiment of the present disclosure. As shown in FIG. 5, the coaching history information database is a database in which information relating to a coaching history of a client or a stakeholder to be coached is stored to be associated with each other. As items that form the information, for example, a variety of information such as “ID (coach and client), (client and stakeholder)”, “date and time”, “coaching progress information”, and “coaching result information” is associated with each other.

The “date and time” information refers to date and time when coaching is executed. The “date and time” information corresponds to “date and time” when a coach coaches a client through each terminal device, for example, and the date and time (information) is stored in association with “ID” information on a client who operates the terminal device 41A and a coach who operates the terminal device 41B. Further, the “date and time” information corresponds to “date and time” when a client coaches a stakeholder through each terminal device, for example, and the date and time (information) is stored in association with “ID” information on a client who operates the terminal device 41A and a stakeholder who operates the terminal device 41C.

Further, the “date and time” information represents “date and time” when a coach coaches a client merely in a face-to-face manner without passing through each terminal device, for example, and the date and time (information) is stored in association with “ID” information on a client who operates the terminal device 41A and a coach who operates the terminal device 41B. Further, the “date and time” information represents “date and time” when a client coaches a stakeholder merely in a face-to-face manner without passing through each terminal device, for example, and the date and time (information) is stored in association with “ID” information on a client who operates the terminal device 41A and a stakeholder who operates the terminal device 41C. When the coaching is executed merely in a face-to-face manner without passing through each terminal device, input of the date and time of execution is performed by at least one user of a coach, a client, and a stakeholder through a terminal device used by each user.

The “coaching progress information” refers to information indicating the progress of coaching executed with respect to a client by a coach or executed with respect to a stakeholder by a client. For example, when a coach coaches a client with respect to a “presentation method”, and when coaching content includes plural methods such as a presentation material creation method, a logical explanation method, and a vocalization method in an oral presentation, the “coaching progress information” is information indicating the progress of coaching such as execution of the entirety or some of the coaching content.

The “coaching result information” refers to information indicating the content of coaching executed with respect to a client by a coach, or executed with respect to a stakeholder by a client. For example, when a coach coaches a client with respect to a “presentation method”, the “coaching information” includes content that is actually explained such as a presentation material creation method, a logical explanation method, or a vocalization method in an oral presentation, utterance content when the client speaks after reception of the explanation, or the like.

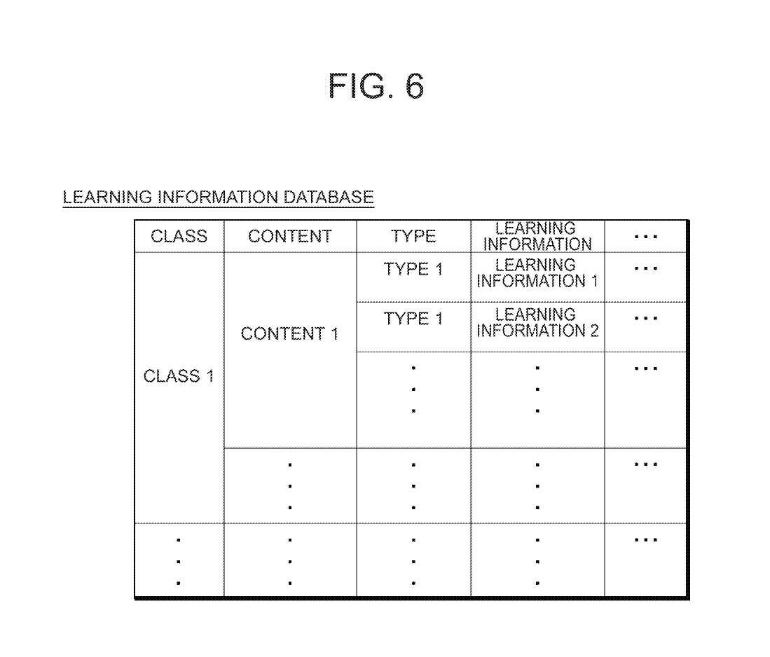

FIG. 6 is a diagram illustrating an example of a learning information database of a management server according to an embodiment of the present disclosure. As shown in FIG. 6, the learning information database is a database in which detailed information of learning information provided to a client is stored to be associated with each other. As items that form the information, a variety of information such as “class”, “content”, “type” (for distinction of simple “learning information” and “question information” such as a test, a check list, or evaluation), or “learning information” is associated with each other.

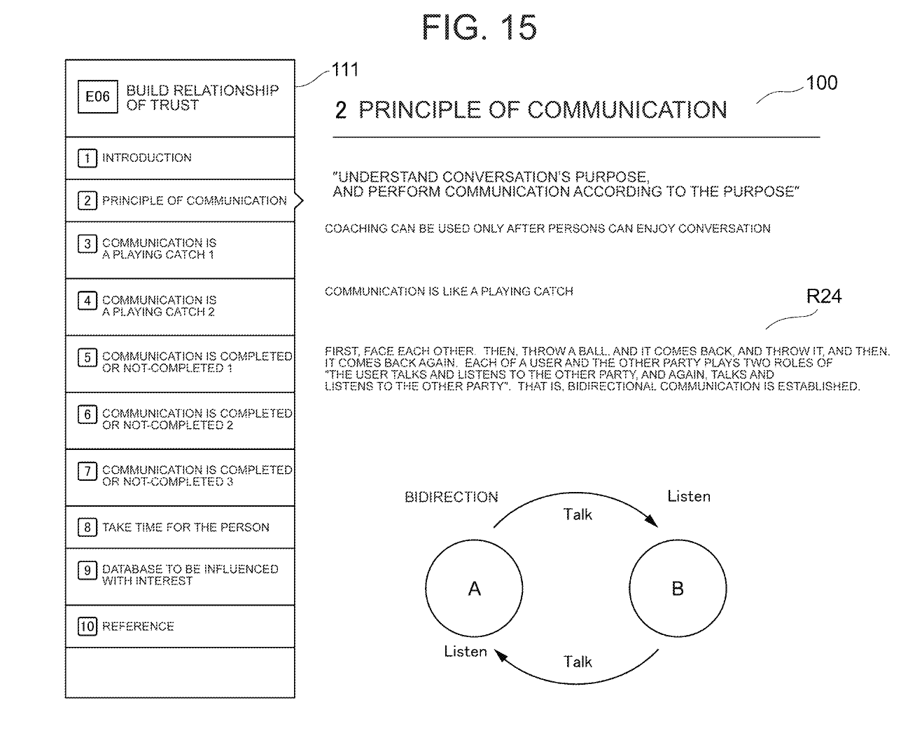

The “class” information is large-sized content including plural pieces of learning information provided by the management server 21, and indicates a learning field. For example, the “class” information corresponds to “E06 build a relationship of trust” (see FIG. 15), and is provided to the terminal device 41A from the management server 21 through the network 51.

The “content” information is medium- or small-sized content including plural pieces of learning information provided by the management server 21, and forms one “class” by combination of plural pieces of “content” information. That is, plural pieces of “content” information are stored in association with one piece of “class” information. For example, in the above-mentioned example of “E06 build a relationship of trust”, the “content” information corresponds to “2 Principle of communication” (see FIG. 15), and is provided to the terminal device 41A from the management server 21 through the network 51.

The “type” information is information for distinction of “simple learning information” (passive information for a participant) for presenting simple information relating to learning and “question information” (active information for a client) of a question type relating to learning such as a test, a check list or evaluation, as described above.

The “learning information” is actual learning information, and as described above, the “simple learning information” or the “question information” is stored as the “learning information” according to the associated “type” information. The “learning information” is provided to the terminal device 41A, 41B, 41C, and the like from the management server 21 through the network 51.

FIG. 7 is a diagram illustrating an example of a learning history information database of a management server according to an embodiment of the present disclosure. As shown in FIG. 7, the learning history information database is a database that represents a history of learning information provided to the terminal device 41A by the management server 21, in which a variety of information such as “ID (client)”, “date and time”, “class”, “content”, “learning information”, “learning progress information”, and “learning result information” is stored to be associated with each other.

The “date and time” information refers to information indicating date and time when the management server 21 provides learning information to the terminal device 41A, and is stored in association with “ID” information of a client who operates the terminal device 41A which is a provision destination.

The “class”, “content”, and “learning information” represents “class”, “content”, and “learning information” provided to the terminal device 41A by the management server 21, and are stored in association with the above-described “ID” and “date and time”. Further, the “class”, “content”, and “learning information” stored in the learning history information database are associated with the “class”, “content”, and “learning information” stored in the above-described “learning information database” (see FIG. 5).

The “learning progress information” and “learning result information” represent “learning progress information” and “learning result information” provided to the management server 21 from the terminal device 41A (or other terminal devices), and are stored in association with the above-described “ID”, “date and time”, “class”, “content”, and “learning information”. The “learning progress information” represents the progress of learning operation information based on an operation of an operation section of the terminal device 41A with respect to learning information provided to the terminal device 41A (or other terminal devices) from the management server 21. The learning operation information includes character information, pointer position information, input determination information, and input cancellation information with respect to learning information provided to the terminal device 41A (or other terminal devices) from the management server 21.

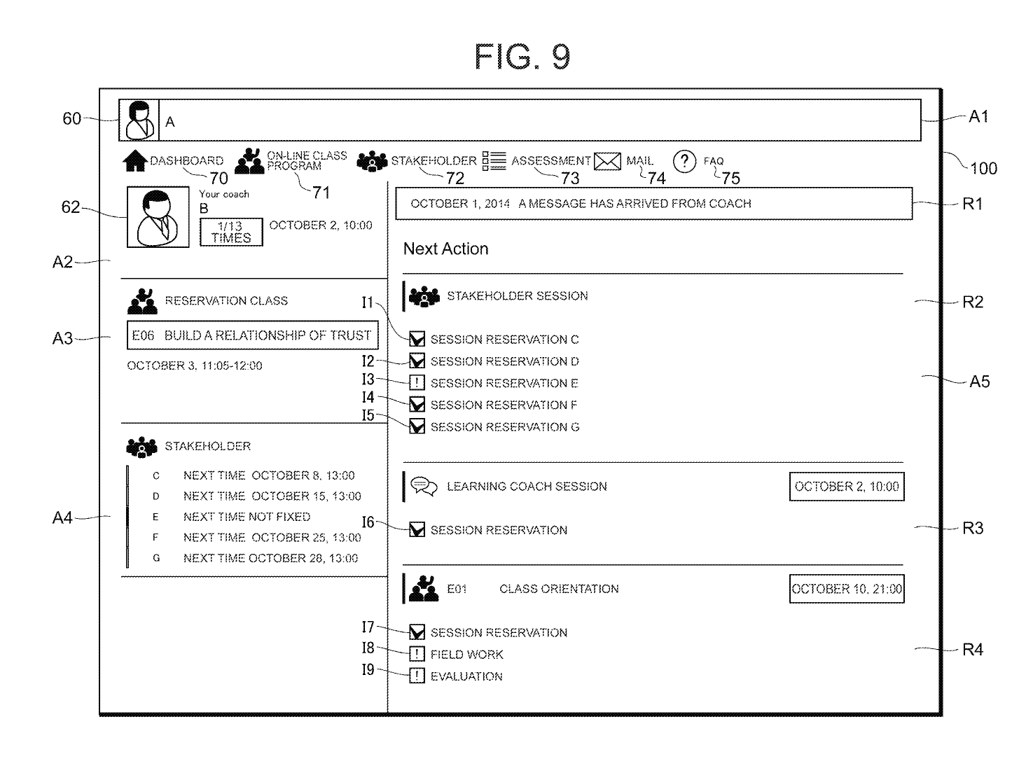

A history of position information of a pointer (see FIG. 9) on a screen, input character information to an input box, or the like, based on an operation of a client using a mouse or the like is stored as the “learning progress information”. The “learning progress information” is information indicating movement and display of a pointer, character information, or the like displayed on a screen in a specific time unit based on an operation of a client. Further, the “learning process information” is not limited to the information indicating the movement and display of the pointer, character information, or the like displayed on the screen in the specific time unit based on the operation of the client, and face information, sound information, or the like of the client in the specific time unit may be additionally stored as the “learning process information”.

The “learning result information” represents a result of learning operation information based on an operation of the operation section of the terminal device 41A with respect to learning information provided to the terminal device 41A (or other terminal devices) from the management server 21. Further, the “learning result information” represents determination information finally input by a client. For example, the “learning result information” represents answer information determined by a client with respect to “question information”. The “learning result information” may be represented as question answer information. The “learning result information” may be information simply indicating a final progress relating to the degree of a current progress of learning.

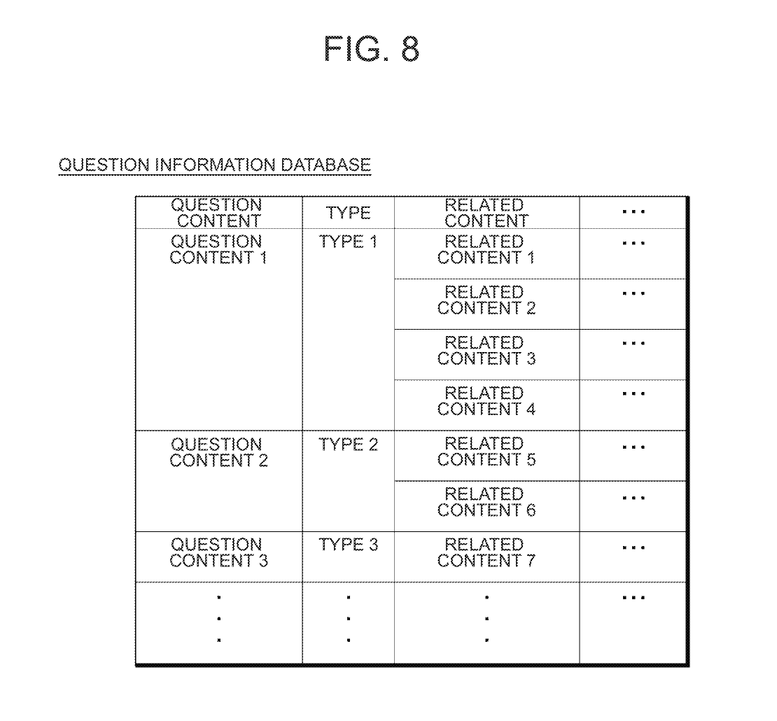

FIG. 8 is a diagram illustrating an example of a question information database of a management server according to an embodiment of the present disclosure. As shown in FIG. 8, the question information database represents detailed content of question information for providing question information to the terminal devices 41A, 41B, 41C, and the like from the management server 21. In the question information database, a variety of information such as “question content”, “type”, and “related content” is stored to be associated with each other.

The “question content” includes information on a test, a check list, evaluation, or the like relating to a question in an assessment performed before, during, or after learning and/or coaching. The “question information” includes information for asking an attribute of a person such as “What is your gender?”, information of “What is your strength?”, and information of “Is your understanding about this theme advanced?”, for example.

The “type” is information for distinction of the type of an answer method with respect to “question content”. The “type” includes an open-ended type for requesting input of a character (a type where a character is input into a blank box), a selective answer type for selecting one answer from plural answers (a type where one check box among plural check boxes is check-input), or the like.

The “related content” refers to information which is stored in association with the “question content”. In the case of the selective answer type in which plural answers are prepared with respect to “question content”, plural pieces of “related content” are associated with one piece of “question content”. The “related content” information in this case represents one piece of option information among plural pieces of option information (and check box information displayed in association therewith). Further, in the case of the open-ended type for requesting input of a character or the like, in which plural answers are not prepared with respect to “question content”, one piece of “related content” is associated with one piece of “question content”. The “related content” in this case represents blank box information.

[Display screen (image) of terminal device]

An example of an image displayed in the display section of the terminal device shown in FIG. 2 will be described with reference to FIGS. 9 to 15. A display screen to be described hereinafter represents a display screen of the terminal device 41A which is a terminal of a client, but the terminal device 41B which is a terminal of a coach and the terminal device 41C which is a terminal of a stakeholder may be configured to display the same display screen. Further, a screen displayed in a certain terminal device may be shared with other terminal devices. Hereinafter, in description with reference to each of FIGS. 9 to 15, description of parts having the same content in the respective drawings may be appropriately omitted.

FIG. 9 shows an example of an image displayed in “dashboard” of a Web page (my-page) for exclusive use of a client. As shown in FIG. 9, menu images 70 to 75 are displayed in an upper part of a my-page 100. Various functions may be executed by operations of the menu images 70 to 75. Further, as shown in FIG. 9, in the my-page 100 of the client, for example, an image 60 indicating the upper part of the body of a client A, is displayed in a client display area A1, and an image 62 indicating the upper part of the body of a coach B, “October 2, 10:00” indicating execution schedule date and time when the second coaching between the client A and the coach B is to be executed, and “ 1/13 times” which is information indicating the number of times of execution of the second coaching are displayed in a coach display area A2. Further, “E06 build a relationship of trust” indicating a reservation class name and “October 3, 11:00 to 12:00” indicating date and time when a reservation class is executed are displayed in a reservation class display area A3, and all or some of stakeholders relating to the client A and execution schedule date and time when the client A executes the first coaching with respect to stakeholders C to G are displayed in a stakeholder display area A4 In the stakeholder display area A4 shown in FIG. 9, the execution schedule date and time when the client A executes the first coaching with respect to the stakeholder C is displayed as “next time October 8, 12:00”, for example, but when the execution schedule date and time is not fixed, like a case where the client A executes the first coaching with respect to the stakeholder E, “next time not fixed” is displayed.

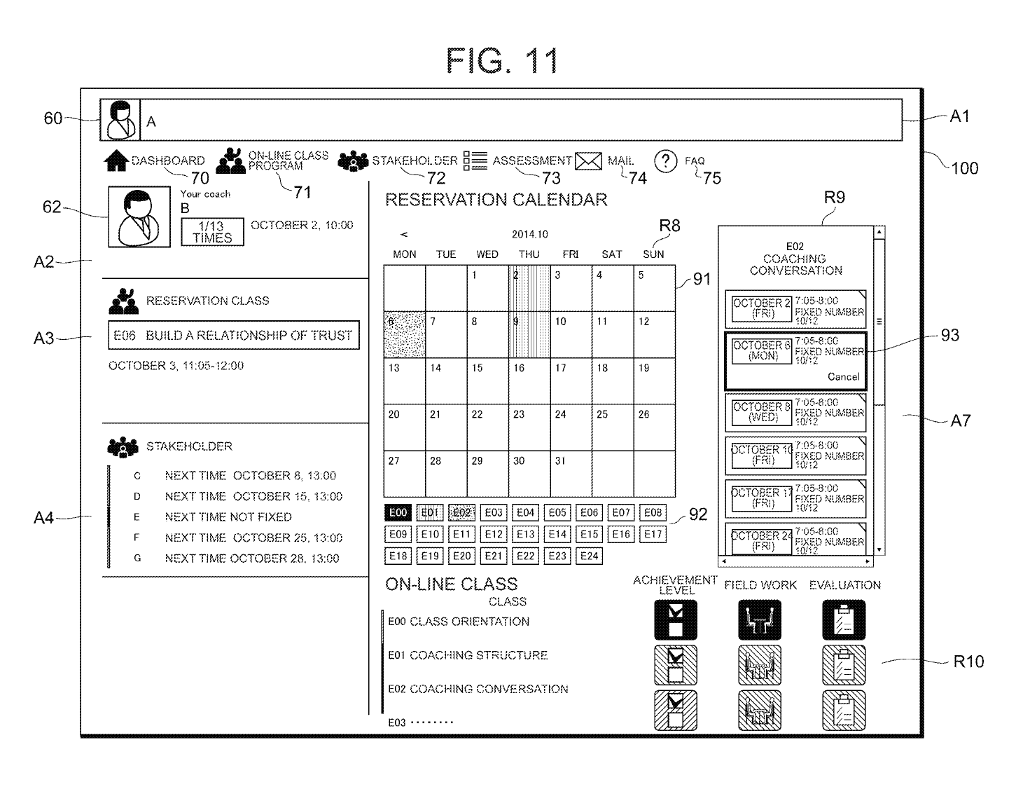

In “Next Action” display area A5 of the my-page 100 in FIG. 9, for example, a display area R1 where an image indicating arrival of a new message for a client is displayed, a display area R2 where an image indicating whether reservation of the first coaching (session) to be executed with respect to each stakeholder by the client A is completed is displayed, a display area R3 where an image indicating whether reservation of the second coaching (session) to be executed with respect to the client A by the coach B is completed is displayed, and a display area R4 where an image indicating a progress state of an on-line class (for example, class name “E01 class orientation”) In which the client A participates is displayed are included. The reservation of the session or on-line class is performed through a schedule reservation screen illustrated in FIG. 11 (which will be described later).

Check images 11 to 15 of check boxes indicating whether the reservation of the first coaching (each section) to be executed with respect to each stakeholder by the client A is completed are displayed in the display area R2 shown in FIG. 9. For example, the check images I1, I2, I4, and I5 represent that the reservation is completed, and the check image I3 represents that the reservation is not completed. Reservation date and time of each session is displayed in the stakeholder display area A4 shown in FIG. 9.

A check image I6 which is a check box indicating whether the reservation of the second coaching (session) to be executed with respect to the client A by the coach B is completed (check box indicating that the reservation is completed) is displayed in the display area R3 shown in FIG. 9.

Check images I7 to I9 which are check boxes indicating a progress state of an on-line class (for example, class name “E01 class orientation”) taken by the client A are displayed in the display area R4 shown in FIG. 9. For example, the check image I7 represents that a participation reservation of class “E01 class orientation” is completed, the check image I8 represents that “field work” to be executed before the lecture is not completed, and the check image I9 represents that “evaluation” indicating evaluation to be executed after the lecture is not completed.

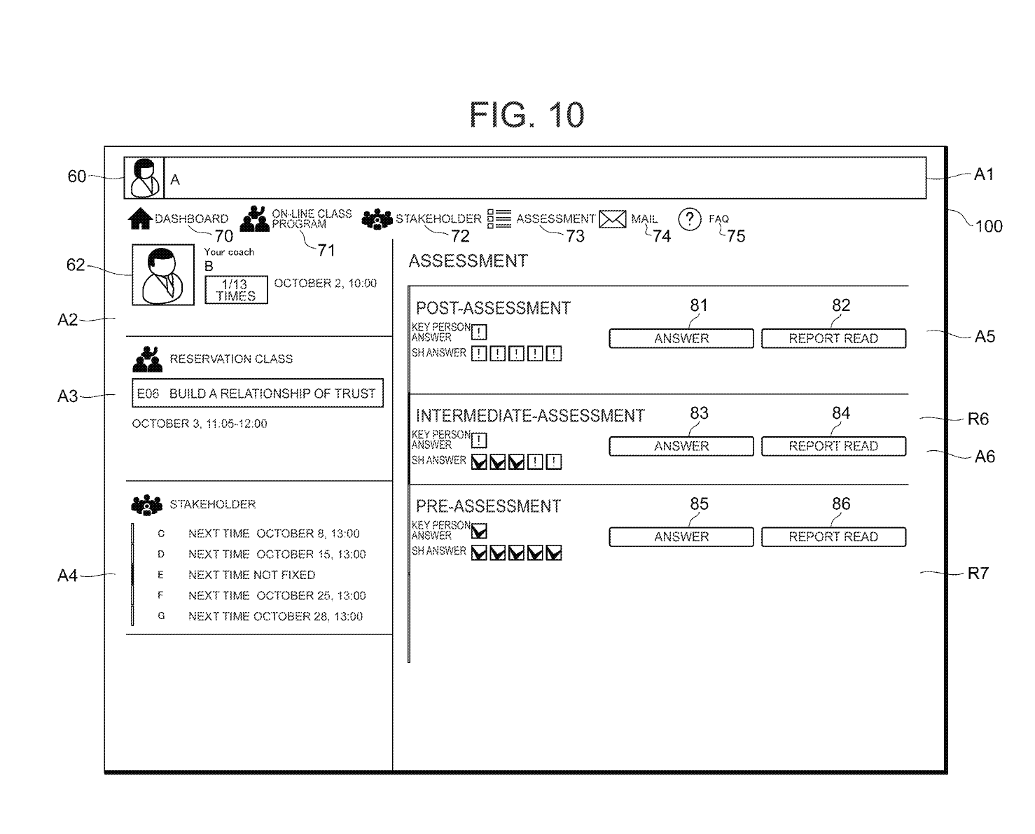

FIG. 10 shows an example of an image displayed in “assessment” of a client exclusive Web page (my-page). As shown in FIG. 10, menu images 70 to 75, client information in a client display area A1, coach information in a coach display area A2, reservation class information in a reservation class display area A3, and stakeholder information in a stakeholder display area A4 are displayed in a my-page 100, similar to FIG. 9.

An “assessment” display area A6 in FIG. 10 includes, for example, a display area R5 where an image indicating a progress state of assessment (post-assessment) to be executed after learning and/or coaching is displayed, a display area R6 where an image indicating a progress state of assessment (intermediate-assessment) to be executed during learning and/or coaching is displayed, and a display area R7 where an image indicating a progress state of assessment (pre-assessment) to be executed before learning and/or coaching is displayed. In this embodiment, the “assessment” is completed by providing a question based on information in a question information database recorded by the recording section 28 of the management server 21 to a client and receiving an answer from the client. The assessment result may be shared between the coach and the client, and between the client and the stakeholder. When executing the first coaching or the second coaching, the assessment result may be utilized in each coaching.

In the display area R5 shown in FIG. 10, at least one check image of a check box indicating whether the post-assessment of the client A and the stakeholder is completed is displayed. Further, an “answer” button 81 and a “report read” button 82 are provided in the display area R5. Here, for example, if the client A selects the “answer” button 81, the my-page is shifted to a Web page where the post-assessment is executed, and if the client A selects the “report read” button 82, the my-page is shifted to a report read Web page where an assessment result already executed by a stakeholder is read.

In the display area R6 shown in FIG. 10, at least one check image of a check box indicating whether the intermediate-assessment of the client A and the stakeholder is completed is displayed. Further, an “answer” button 83 and a “report read” button 84 are provided in the display area R6. Here, for example, if the client A selects the “answer” button 83, the my-page is shifted to a Web page where the post-assessment is executed, and if the client A selects the “report read” button 84, the my-page is shifted to a report read Web page where an assessment result already executed by a stakeholder is read.

In the display area R7 shown in FIG. 10, at least one check image of a check box indicating whether a pre-assessment of the client A and the stakeholder is completed is displayed. Further, an “answer” button 85 and a “report read” button 86 are provided in the display area R7. Here, for example, if the client A selects the “answer” button 85, the my-page is shifted to a Web page where the post-assessment is executed, and if the client A selects the “report read” button 86, the my-page is shifted to a report read Web page where an assessment result already executed by a stakeholder is read.

FIG. 11 shows an example of an image displayed in an “on-line class program” of a client exclusive Web page (my-page). As shown in FIG. 11, menu images 70 to 75, client information in a client display area A1, coach information in a coach display area A2, reservation class information in a reservation class display area A3, and stakeholder information in a stakeholder display area A4 are displayed in a my-page 100, similar to FIGS. 9 and 10.

A schedule reservation display area A7 shown in FIG. 11 includes a calendar display area R8 where a reservation calendar 91 and an on-line class button (E00 to E024) 92 are displayed, a reservation class display area R9 where reservation date and time 93 of a reservation class and reservation date and time candidates are displayed, and a class progress display area R10 where the progress of each on-line class is displayed, for example.

In the calendar display area R8 shown in FIG. 11, a client selects at least one of E00 to E24 of the on-line class button 92 and registers the selected result in the reservation calendar 91 to create his/her own learning schedule. The schedule creation may be collectively performed with respect to each of classes E00 to E24, and schedules for the next six months may be created. The schedule creation is not only performed with respect to the on-line class, but may also be performed with respect to the second coaching between the client A and the coach B, the first coaching between the client A and each stakeholder, other training sessions, or the like.

In the reservation class display area R9 shown in FIG. 11, reservation date and time 93 “October 6 (Monday) 7:05-8:00” of an on-line class “E02 coaching conversation” and reservation date and time candidates are displayed, for example. In the reservation class display area R9, the fixed number of a class executed at predetermined date and time is also displayed, in addition to the reservation date and time and the reservation date and time candidates.

In the class progress display area R10 shown in FIG. 11, an “achievement level” icon, a “field work” icon, and an “evaluation” icon are displayed with respect to each class, for example. In the class progress display area R10, for example, with respect to the progress of “E00 class orientation”, the “field work” and the “evaluation” are “completed”, and the “achievement level” status is “achieved (completed)”. Further, for example, with respect to the progress of “E01 coaching structure”, the “field work” and the “evaluation” are “not completed”, and the “achievement level” status is “not achieved (not completed)”.

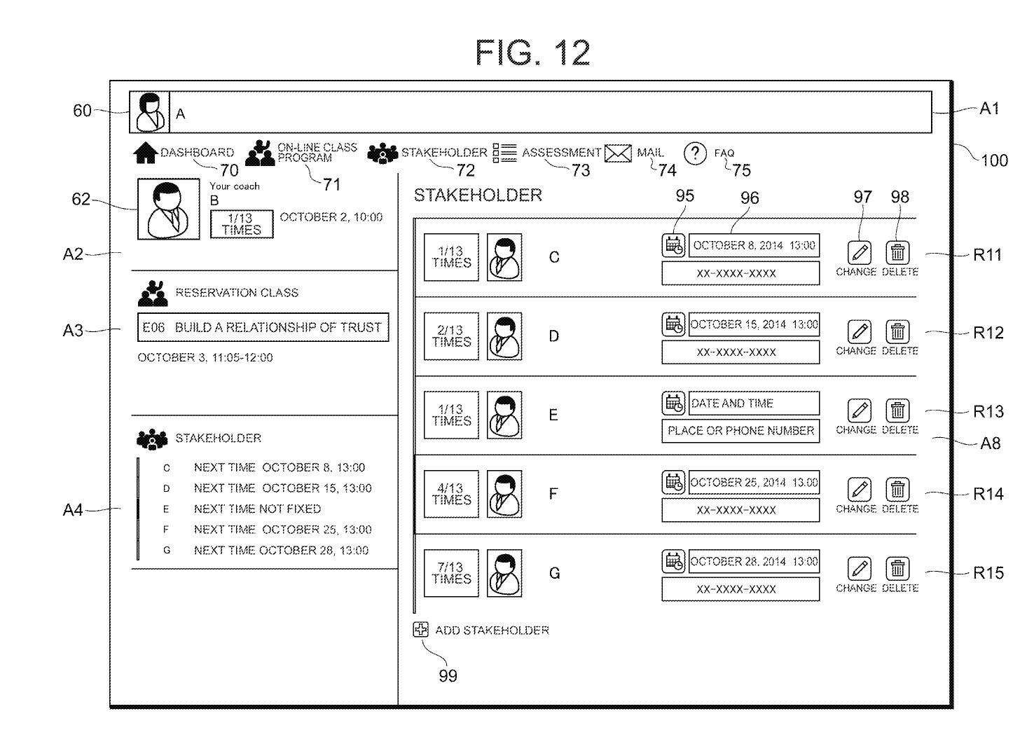

FIG. 12 shows an example of an image displayed in “stakeholder” of a client exclusive Web page (my-page). As shown in FIG. 12, menu images 70 to 75, client information in a client display area A1, coach information in a coach display area A2, reservation class information in a reservation class display area A3, and stakeholder information in a stakeholder display area A4 are displayed in a my-page 100, similar to FIGS. 9 and 11.

A “stakeholder” display area A8 shown in FIG. 12 includes a schedule adjustment display area R11 for a stakeholder C, a schedule adjustment display area R12 for a stakeholder D, a schedule adjustment display area R13 for a stakeholder E, a schedule adjustment display area R14 for a stakeholder F, and a schedule adjustment display area R15 for a stakeholder G, for example.

For example, it can be understood that in the schedule adjustment display area R11 of the stakeholder C shown in FIG. 12, “Oct. 8, 2014, 13:00” is displayed in a reservation date and time section 96 of the first coaching between the client A and the stakeholder C and a reservation of the first coaching is “Oct. 8, 2014, 13:00”. Further, in the schedule adjustment display area R11, if a calendar button 95 is selected, the reservation date and time can be changed, and if a change button 97 is selected, the stakeholder C is changed to a different stakeholder. Further, if a delete button 98 is selected, the stakeholder C is deleted. If a “add stakeholder” button 99 is selected, a new stakeholder is added.

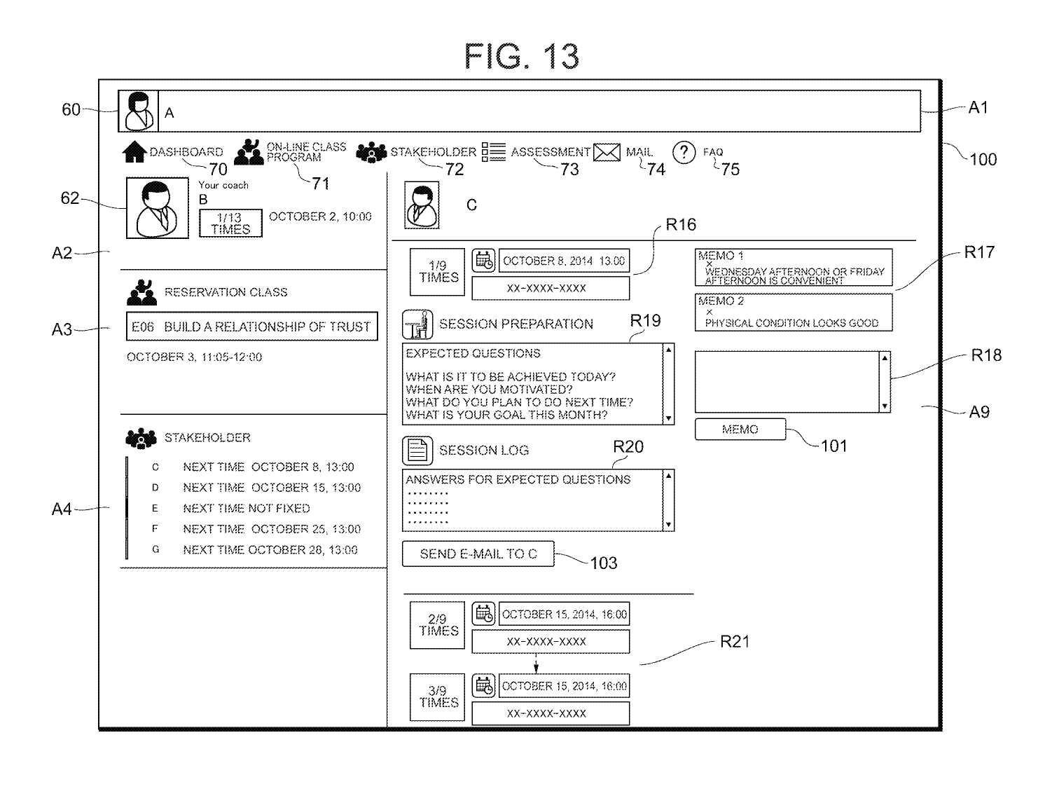

FIG. 13 shows an example of an image displayed in “stakeholder” of a client exclusive Web page (my-page), which particularly shows a page where a coaching history of a client and a stakeholder C is written and a page where a future coaching plan is displayed. As shown in FIG. 13, menu images 70 to 75, client information in a client display area A1, coach information in a coach display area A2, reservation class information in a reservation class display area A3, and stakeholder information in a stakeholder display area A4 are displayed in a my-page 100, similar to FIGS. 9 to 12.

A “stakeholder” personal display area A9 shown in FIG. 13 includes a coaching status display area R16 where reservation date and time of the first coaching between the client A and the stakeholder C, the number of times of coaching, a telephone number of the stakeholder C, and the like are displayed, a memo display area R17 where a memo registered with respect to the stakeholder C is displayed, a memo registration display area R18 where a memo is registered, a memo registration display area R19 where a memo for preparation of the first coaching (“session”) between the client A and the stakeholder C is registered, a log registration display area R20 where a history (“session log”) of a session is registered, and a session display area R21 where a session schedule and/or a session log between the client A and the stakeholder C is displayed.

In the memo registration display area R18, a text is input into a blank corresponding to the area, and when a memo button 101 is clicked, the input text is registered, and is displayed as a memo 3 in the memo display area R17.

In the log registration display area R20, a session log is registered as a text, but it is not essential that the session log is registered as the text. For example, the session log may be registered as a still image, a moving image, sound, or the like. When a mail transmission button 103 is clicked, the session log is transmitted to a stakeholder.

In the session display area R21, a session schedule and/or a session log between the client A and the stakeholder C may be list-displayed. In the example shown in FIG. 13, second and third reservation schedules of the session schedule between the client A and the stakeholder C are displayed, but the list display may be performed up to a ninth reservation schedule. As a specific session log is registered, the session log is displayed.

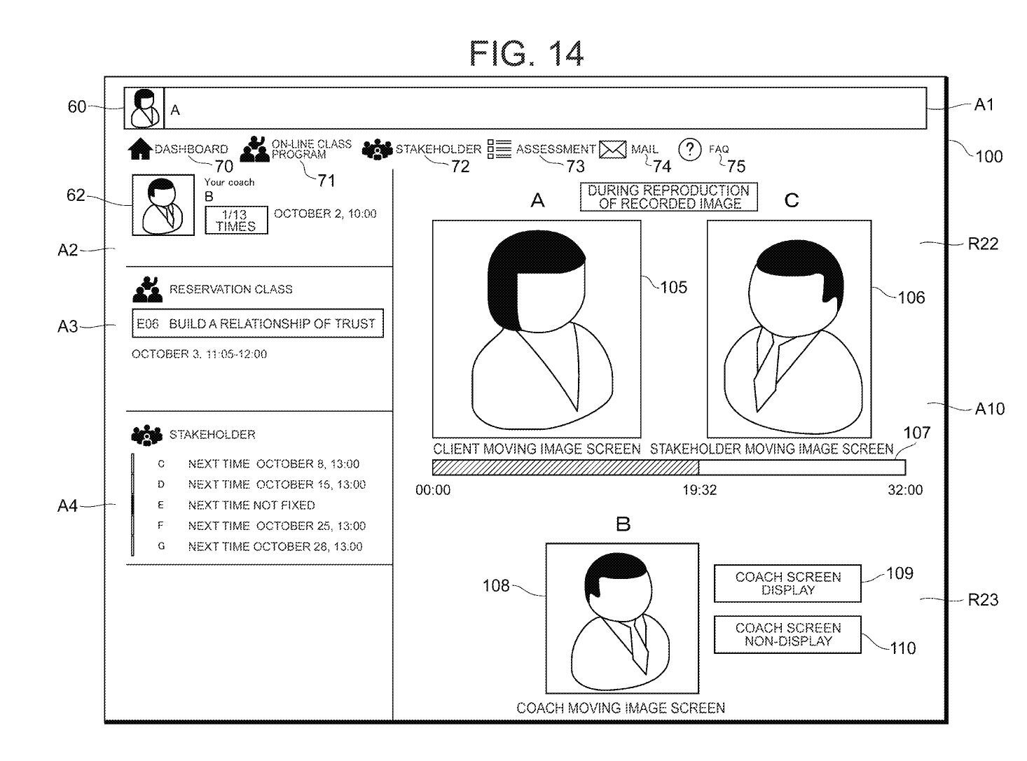

FIG. 14 shows an example of a moving image indicating an example of the second coaching to be executed with a client A by a coach B in a client exclusive Web page (my-page). As shown in FIG. 14, menu images 70 to 75, client information in a client display area A1, coach information in a coach display area A2, reservation class information in a reservation class display area A3, and stakeholder information in a stakeholder display area A4 are displayed in a my-page 100, similar to FIGS. 9 to 13.

A moving image reproduction area A10 shown in FIG. 14 includes a moving image display area R22 where a recording moving image of the first coaching between the client A and the stakeholder C is displayed, and a moving image display area R23 where a status of the coach B is displayed as a moving image.

The recording image displayed in the moving image display area R22 includes a moving image screen 105 of the client A, a moving image screen 106 of the stakeholder C, and a bar 107 indicating a reproduction status of the moving image.

The moving image display area R23 includes a moving image screen 108 where an actual status of the coach B is displayed in real time in the second coaching, a “coach screen display” button 109 capable of controlling display and non-display of the moving image screen 108, and a “coach screen non-display” button 110.

As described above, in the second coaching executed with respect to the client A by the coach B, since the coach B can feed back the content and result of the first coaching to the client A while checking the status of the first coaching using the moving image, it is possible to efficiently execute the second coaching compared with a case where the log of the first coaching is a simple text.

FIG. 15 is a diagram illustrating an example of a piece of content “2 Principle of communication” of an on-line class “E06 build a relationship of trust”. As shown in FIG. 15, in a my-page 100, as an operator selects each tab 111, any one of respective pieces of content “1 Introduction” to “10 Reference” of the on-line class “E06 build a relationship of trust” may be displayed in the content display area R24. Each piece of content is configured by a text, a figure, or the like as shown in the content display area R24 shown in FIG. 15, and is configured to efficiently enhance the ability of the client. Each piece of content is not necessarily provided to the client in the form of an image, and may be provided in the form of sound or the like.

(Operation)

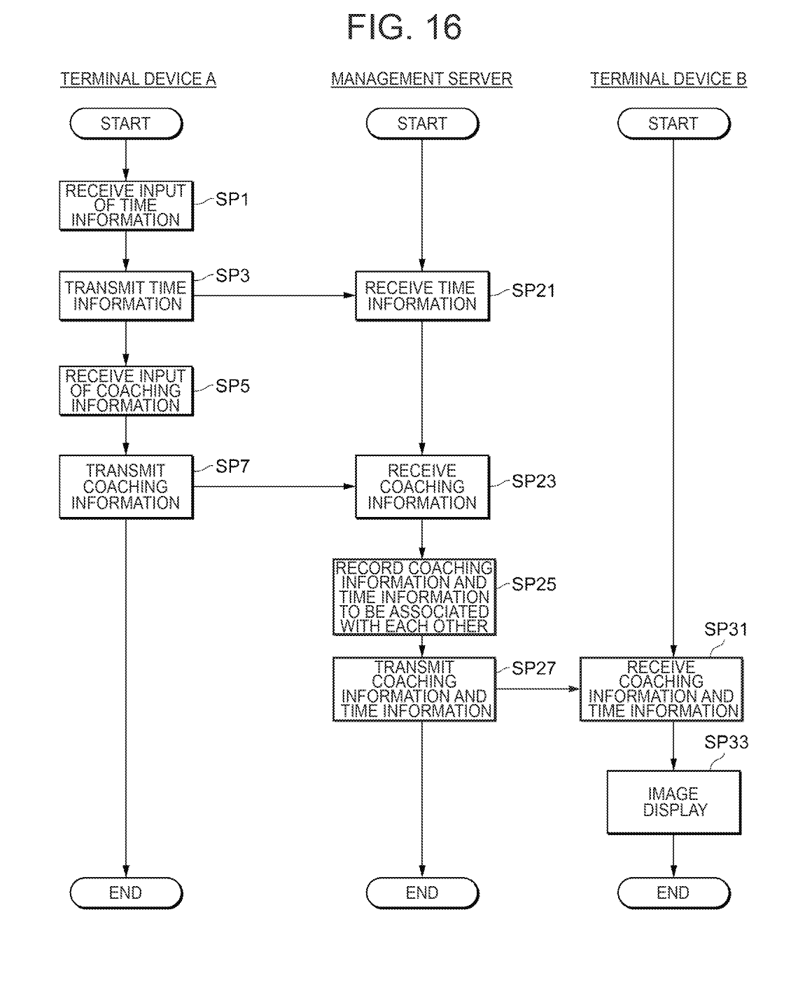

FIG. 16 is a diagram illustrating an example of a flowchart of a coaching support system according to an embodiment of the present disclosure. FIG. 16 particularly shows an example of a flowchart when a log of the first coaching to be executed with respect to a stakeholder by the client A is displayed in a my-page of the coach in the terminal device 41B of the coach. In this embodiment, description will be made assuming that a predetermined process (login or the like) for displaying a my-page is terminated. Various processes in the following procedure are executed based on a control command from the CPU 42 of the terminal device 41 or the CPU 22 of the management server 21. That is, the CPU 42 or the CPU 22 functions as a control section.

As shown in FIG. 16, first, the terminal device 41A (first terminal) of a client receives an input of time information indicating execution schedule date and time when the client executes the first coaching with respect to a stakeholder (stakeholder of the client) (step SP1).

Then, the terminal device 41A of the client transmits the time information to the management server 21 (step SP3). The management server 21 receives the time information from the terminal device 41A of the client (step SP21).

Then, the terminal device 41A of the client further receives an input of coaching information including coaching history information indicating a history of the first coaching (step SP5).

Then, when the input of the coaching information is received, the terminal device 41A of the client further transmits the coaching information to the management server 21 (step SP7). The management server 21 receives the coaching information from the terminal device 41A of the client (step SP23).

Then, the management server 21 records the coaching information from the terminal device 41A of the client in association with the time information (step SP25).

Then, the management server 21 transmits the time information and the coaching information (at least the coaching information) to at least the terminal device 41B of a coach (leader) so that at least the coaching information associated with the time information can be used in the second coaching to be executed with respect to the client by the coach (step SP27).

Then, the terminal device 41B of the coach receives the time information and the coaching information (at least the coaching information) (step SP31). Thereafter, the terminal device 41B of the coach displays the time information and the coaching information (at least the coaching information). Further, the terminal device 41B of the coach displays coaching information for every date and time when the first coaching is executed, based on the time information and the coaching information associated with the time information transmitted from the management server 21.

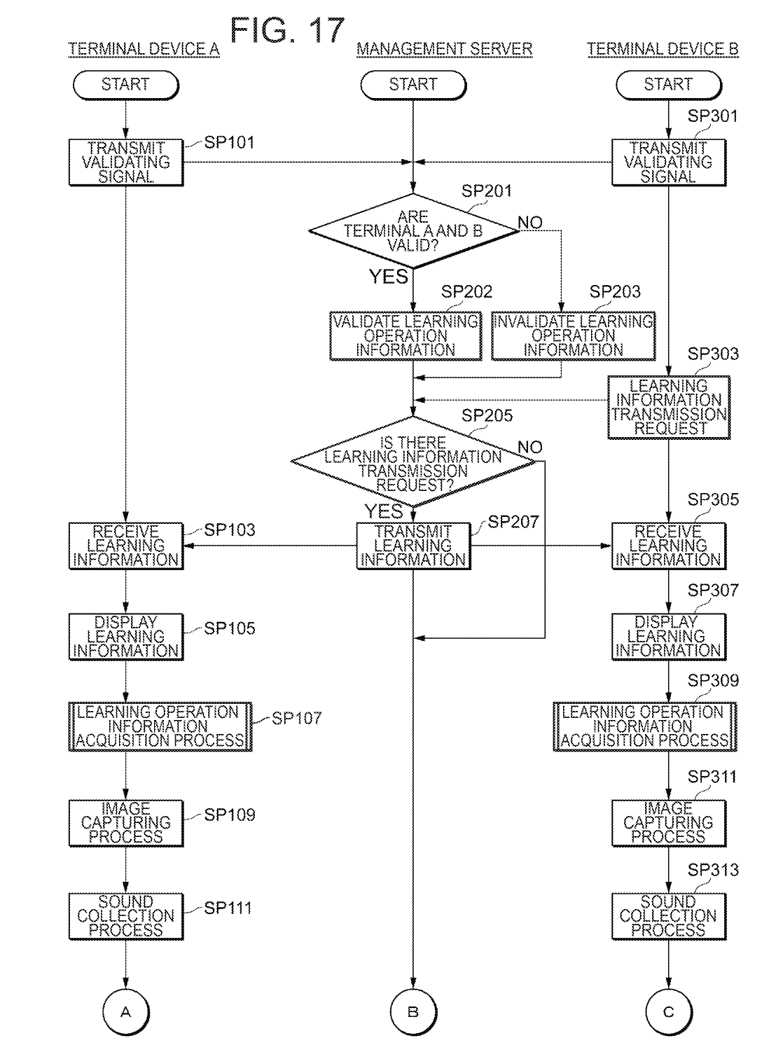

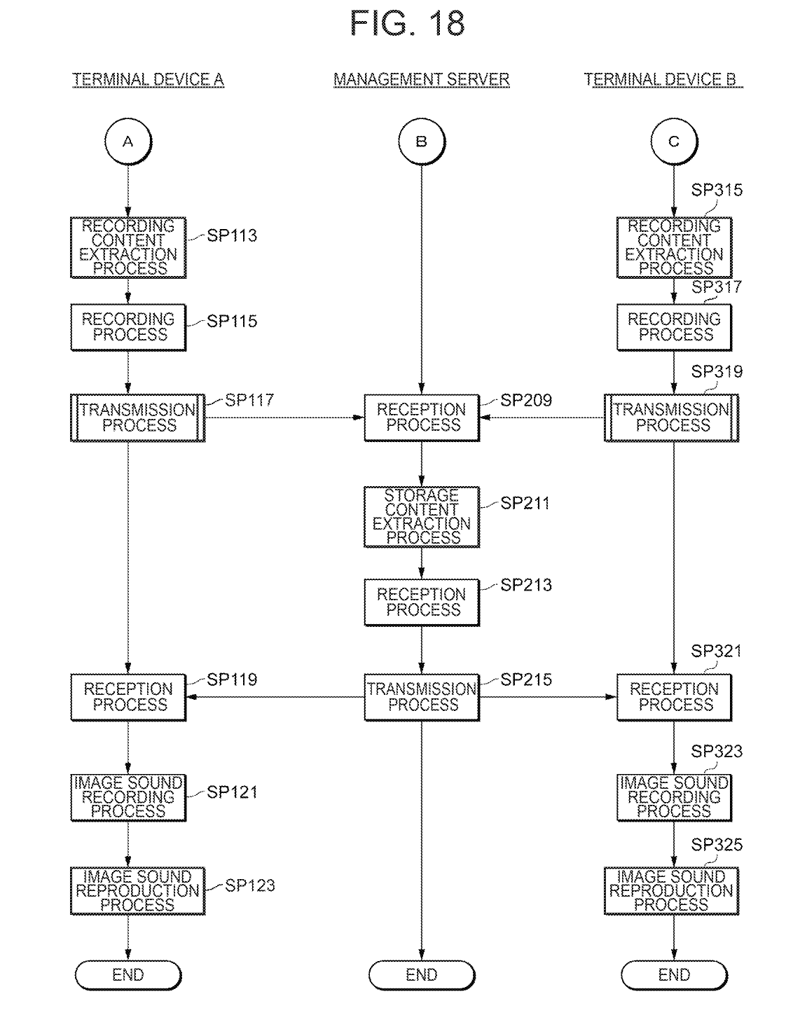

FIGS. 17 and 18 are diagrams illustrating examples of flowcharts of a coaching support system according to an embodiment of the present disclosure. Particularly, FIGS. 17 and 18 show flowcharts of this system when a coach executes the second coaching with respect to a client through both of the terminal devices 41A and 41B. In description of FIGS. 17 and 18, the meaning of “learning” includes “coaching”. For example, “learning information” may be referred to as learning/coaching operation information or coaching information, and “learning operation information” may be referred to as learning/coaching operation information or coaching operation information. In this embodiment, a process of the coaching support system in the second coaching is described with reference to the processing flowcharts in FIGS. 17 and 18, but the processing flowcharts in FIGS. 17 and 18 may be employed in a process of the coaching support system in the first coaching. Various processes in the following procedure are executed based on a control command from the CPU 42 of the terminal device 41 or the CPU 22 of the management server 21. That is, the CPU 42 or the CPU 22 functions as a control section.

As shown in FIG. 17, first, the terminal devices 41A and 41B execute a validating signal transmission process (step SP101 and step SP301). In this process, a CPU 42A (42B) transmits a validating signal to the server 21 through a communication I/F 46A (46B). The validating signal includes “ID” information, password information, or the like of a person who participates in a lecture and a leader. When the process is terminated, the procedure proceeds to step S103 (step SP303).

On the other hand, the management server 21 determines whether the terminal device 41A and the terminal device 41B are valid (step SP201). In this process, the CPU 22 receives validating signals from the terminal devices 41A and 41B to determine whether the terminal device 41A and the terminal device 41B are valid. When it is determined that the terminal device 41A and the terminal device 41B are valid, the CPU 22 causes the procedure to proceed to step SP202, and when it is determined that the terminal device 41A and the terminal device 41B are not valid, the CPU 22 causes the procedure to proceed to step S203.

Then, in the process of the above-described step SP201, when it is determined that the terminal device 41A and the terminal device 41B are valid, the CPU 22 performs a process of validating learning operation information (step SP202), and when it is determined that the terminal device 41A and the terminal device 41B are not valid, the CPU 22 performs a process of invalidating learning operation information (step SP203). When these processes are terminated, the procedure proceeds to step SP204.

On the other hand, the terminal device 41B performs a learning information transmission request process (step SP303). In this process, the CPU 42B performs the learning information transmission request with respect to the management server 21 through a communication I/F 46B. When this process is terminated, the procedure proceeds to step SP305.

On the other hand, the management server 21 determines whether the learning information transmission request is present (step SP205). In this process, the CPU 22 determines whether the learning information transmission request is received from the terminal device 41B. When it is determined that the learning information transmission request is received from the terminal device 41B, the CPU 22 causes the procedure to proceed to step SP207, and when it is determined that the learning information transmission request is not received from the terminal device 41B, the CPU 22 causes the procedure to proceed to B.

Then, in the process of the above-described step SP205, when it is determined that the learning information transmission request is received from the terminal device 41B, the CPU 22 performs a learning information transmission process (step SP207). In this process, the CPU 22 reads “class”, “content”, and “learning information” based on the learning history information database shown in FIG. 7 and the learning information database shown in FIG. 6. Further, the CPU 22 transmits the read information to the terminal devices 41A and 41B through the communication I/F 26. When this process is terminated, the procedure proceeds to B.

On the other hand, the terminal devices 41A and 41B perform a learning information reception process (step SP103 and step SP305). In this process, the CPU 42A (42B) receives learning information (step SP207) transmitted from the management server 21 through the communication I/F 46A (46B). Further, the CPU 42A (42B) stores the received learning information in a memory 43A (43B) and a storage section 48A (48B). When this process is terminated, the procedure proceeds to step SP105 (step SP307).

Then, a learning information display process is performed (step SP105 and step SP307). In this process, the CPU 42A (42B) displays the received learning information in a display section 44A (44B). When this process is terminated, the procedure proceeds to step SP107 (step SP309).

Then, a learning operation information acquisition process is performed (step SP107 and step SP309). In this process, the CPU 42A (42B) acquires learning operation information such as text information, pointer position information, determination information of input information, or cancellation information of input information, input based on an operation of the operation section 45 from a client and a coach. When this process is terminated, the procedure proceeds to step SP109 (step SP311).

Then, an image capturing process is performed (step SP109 and step SP311). In this process, the CPU 42A (42B) captures a still image or a moving image of the face (body) of the client and the coach by the imaging section 50, and stores information of the captured image information in the memory 43A (43B). When this process is terminated, the procedure proceeds to step SP111 (step SP313).

Then, a sound collection process is performed (step SP111 and step SP313). In this process, the CPU 42A (42B) collects sounds of a person who participates in a lecture and a leader by the sound collection section 47, and stores the collected sound information in the memory 43A (43B). When this process is terminated, the procedure proceeds to A (C).

Then, a storage content extraction process is performed (step SP113 and step SP315). In this process, the CPU 42A (42B) extracts learning operation information such as text information, pointer position information, determination information of input information, or cancellation information of input information; image information of a client and a coach; and sound information of a client and a coach, acquired in the process of the above-described step. When this process is terminated, the procedure proceeds to step SP115 (step S317).

Then, a storage process is performed (step SP115 and step SP317). In this process, the CPU 42A (42B) stores learning operation information such as text information, pointer position information, determination information of input information, or cancellation information of input information; image information of a client and a coach; and sound information of a client and a coach, extracted in the process of the above-described step SP113 (step SP315) in the storage section 48A (48B) as learning history information managed by a terminal device. When this process is terminated, the procedure proceeds to step SP117 (step SP319).

Then, a transmission process is performed (step SP117 and step SP319). In this process, the CPU 42A (42B) transmits transmission data generated based on learning operation information such as text information, pointer position information, determination information of input information, or cancellation information of input information, and image information and sound information of a client and a coach, stored in the storage section 48A (48B) in the process of the above-described step SP115 (step SP317) to the terminal devices 41A and 41B through the communication I/F 46A (46B). When this process is terminated, the procedure proceeds to step SP119 (step SP321).

On the other hand, the management server 21 performs a reception process (step SP209). In this process, the CPU 22 receives transmission data generated based on learning operation information such as text information, pointer position information, determination information of input information, or cancellation information of input information, and image information and sound information of a client and a coach, transmitted from the terminal devices 41A and 41B, and stores the received transmission data in the memory 23. When this process is terminated, the procedure proceeds to step SP211.

Then, a storage content extraction process is performed (step SP211). In this process, the CPU 22 reads transmission data stored in the memory 23, and extracts learning operation information such as text information, pointer position information, determination information of input information, or cancellation information of input information, and image information and sound information of a client and a coach, from the read transmission data. When this process is terminated, the procedure proceeds to step SP212.

Then, a storage process is performed (step SP212). In this process, the CPU 22 stores information extracted in the process of the above-described step SP211 in a learning history information database stored in the storage section 28. When this process is terminated, the procedure proceeds to step SP213.

Then, a transmission process is performed (step SP215). In this process, the CPU 22 transmits information stored in the learning history information database of the storage section 28 in the process of the above-described step SP212 to the terminal devices 41A and 41B through the communication I/F 26. Further, here, the CPU 22 transmits information transmitted from the terminal device 41A to the terminal device 41B, and transmits information transmitted from the terminal device 41B to the terminal device 41A. The CPU 22 may transmit information transmitted from the terminal device 41A to the terminal device 41A, and may transmit information transmitted from the terminal device 41B to the terminal device 41B, as necessary. When this process is terminated, the flowchart in the management server 21 is terminated.

On the other hand, the terminal devices 41A and 41B perform a reception process (step SP119 and step SP321). In this process, the CPU 42A (42B) receives information transmitted from the management server 21 through the communication I/F 46A (46B). Further, here, information transmitted from the management server 21 corresponds to information on the terminal device 41B in the terminal device 41A, and corresponds to information on the terminal device 41A in the terminal device 41B. Further, the information transmitted from the management server 21 corresponds to learning operation information such as text information, pointer position information, determination information of input information, or cancellation information of input information, and image information and sound information of a client and a coach. When this process is terminated, the procedure proceeds to step SP121 (step SP323).

Then, an image/sound storage process is performed (step SP121 and step SP323). In this process, the CPU 42A (42B) stores information received from the management server 21 in the process of the above-described step SP119 (step SP321) in the memory 43A (43B) and the storage section 48A (48B). When this process is terminated, the procedure proceeds to step SP123 (step SP325).

Then, an image display process is performed (step SP123 and step SP325). In this process, the CPU 42A (42B) displays an image in the display section 44A (44B) based on learning operation information such as text information, pointer position information, determination information of input information, or cancellation information of input information, and image information of a client and a coach, stored in the memory 43A (43B) and the storage section 48A (48B) in the process of the above-described step SP121 (step SP323). Further, the CPU 42A (42B) performs a sound generation process (step SP123 and step SP325). In this process, the CPU 42A (42B) causes a sound generation section 49A (49B) to generate a sound based on sound information of a client and a coach stored in the memory 43A (43B) and the storage section 48A (48B) in the process of the above-described step SP121 (step SP323). When this process is terminated, the flowchart in the terminal devices 41A and 41B is terminated.

(Effects)

According to the above-described embodiments of the present disclosure, it is possible to record coaching information including coaching history information indicating a history of a first coaching executed with respect to a stakeholder (for example, a subordinate) by a client (for example, a boss) in association with date and time when the coaching is executed, and to share the coaching information between the client, a coach, and the stakeholder, and thus, it is possible to use the coaching information as feedback information of coaching when the coach executes a second coaching with respect to the client. As a result, from the standpoint of the coach, it is possible to appropriately support the client so that the client who is directly coached by the coach executes an appropriate coaching with respect to stakeholders of the client, and thus, it is possible to promote a spontaneous action change through coaching from the client with respect to stakeholders (for example, subordinates of the client or colleagues in other departments) in addition to the client who is directly coached by the coach, and to realize a change of the entire organization including the client and the stakeholders.

### Other Modification Examples

The above-described embodiments are made for easy understanding of the present disclosure, but should not be construed to limit the scope of the present disclosure. The present disclosure may include modifications or improvements (for example, combinations of the embodiments or omissions of a part of the components of the embodiments) in a range without departing from the spirit thereof, and also includes equivalents thereof. For example, the respective processing steps described in FIGS. 16 to 18 may be executed in an arbitrarily changed order, or may be executed in parallel, in a range where a contradiction does not occur in processing contents.

In the coaching support system 10 of the present embodiment, a configuration in which the management server 21 has the above-described various functions is provided, but the present disclosure is not limited thereto, and other configurations may be provided. For example, it is preferable that at least a part of the functions of the above-described management server 21 is provided in a terminal (for example, at least one device of the terminal devices 41A, 41B, and 41C) capable of being operated by at least one person of a coach, a client, and a stakeholder.

A part or all of the embodiments may be disclosed as the following appendixes, but the present disclosure is not limited thereto.

(Appendix 1)

A client terminal connected to communicate with a terminal of a leader through a management server, including:

an input reception section that receives an input of time information indicating execution schedule date and time when a client executes a first coaching with respect to a stakeholder of the client; and

a transmission section that transmits the time information to the management server,

the input reception section further receiving an input of coaching information including coaching history information indicating a history of the first coaching, and

the transmission section further transmitting the coaching information to the management server when the input of the coaching information is received in the input reception section.

(Appendix 2)

A management server that relays a first terminal which is a terminal of a client and a second terminal which is a terminal of a leader to communicate with each other, including:

a recording section that records time information indicating execution schedule date and time when the client executes a first coaching with respect to a stakeholder of the client and coaching information including coaching history information indicating a history of the first coaching, transmitted from the first terminal, to be associated with each other; and

a transmission section that transmits at least the coaching information to at least the second terminal so that the coaching information associated with the time information can be used in a second coaching to be executed with respect to the client by the leader.

1. A coaching support system comprising a first terminal which is a terminal of a client and a second terminal which is a terminal of a leader, the first and second terminals being connected to communicate with each other through a management server,
the first terminal comprising
an input reception section that receives an input of time information indicating execution schedule date and time when the client executes a first coaching with respect to a stakeholder of the client, and
a first transmission section that transmits the time information to the management server,
the input reception section further receiving an input of coaching information including coaching history information indicating a history of the first coaching,
the first transmission section further transmitting the coaching information to the management server when the input of the coaching information is received in the input reception section, and
the management server comprising
a recording section that records the coaching information from the first terminal in association with the time information, and
a second transmission section that transmits at least the coaching information to at least the second terminal so that the coaching information associated with the time information can be used in a second coaching to be executed with respect to the client by the leader.

2. The coaching support system according to claim 1,
wherein at least one of the first terminal and the second terminal further comprises a display control section that performs a control so that the coaching information is displayed for every execution schedule date and time when the first coaching is executed, based on the time information transmitted from the second transmission section and the coaching information associated with the time information.

3. The coaching support system according to claim 2,
wherein the display control section list-displays the associated coaching information for every execution schedule date and time.

4. The coaching support system according to claim 1, further comprising a schedule creation section that creates a participation plan based on date and time when the client participates in a predetermined lecture,
wherein the schedule creation section creates the participation plan based on lecture information indicating a lecture desired by the client, and participation time information indicating a desired participation time based on date and time, received from the client.

5. A coaching support method in which a first terminal which is a terminal of a client and a second terminal which is a terminal of a leader are connected to communicate with each other through a management server, the method comprising:
causing the first terminal
to receive an input of time information indicating execution schedule date and time when the client executes a first coaching with respect to a stakeholder of the client,
to transmit the time information to the management server,
further to receive an input of coaching information including coaching history information indicating a history of the first coaching, and
further to transmit the coaching information to the management server when the input of the coaching information is received; and
causing the management server
to record the coaching information from the first terminal in association with the time information, and
to transmit at least the coaching information to at least the second terminal so that the coaching information associated with the time information can be used in a second coaching to be executed with respect to the client by the leader.

6. A computer-readable recording medium on which processes for causing a computer to realize the steps of:
receiving an input of time information indicating execution schedule date and time when the client executes a first coaching with respect to a stakeholder of the client, and further receiving an input of coaching information including coaching history information indicating a history of the first coaching;
transmitting the time information to the a management server, and further transmitting the coaching information to the management server when the input of the coaching information is received;
recording the coaching information in association with the time information; and
transmitting at least the coaching information so that the coaching information associated with the time information can be used in a second coaching to be executed with respect to the client by a leader.
